(19) United States
(12) Patent Application Publication
(10) Pub. No.: US 2008/0289036 A1
(43) Pub. Date: Nov. 20, 2008

(54) TIME-BASED CONTROL OF USER ACCESS IN A DATA PROCESSING SYSTEM INCORPORATING A ROLE-BASED ACCESS CONTROL MODEL

(76) Inventors: MADHUSUDANAN KANDASAMY, Tamil Nadu (IN); Vidya Ranganathan, Bangalore (IN); Ravi A. Shankar, Austin, TX (US)

Correspondence Address: IBM CORP (YA);C/O YEE & ASSOCIATES PC, P.O. BOX 802333, DALLAS, TX, 75380, US

(21) Appl. No.: 11/751,010

(22) Filed: May 19, 2007

(51) Int. Cl. H04L 9/32

(52) U.S. Cl. 726/21

(57) ABSTRACT

Computer implemented method, system and computer usable program code for providing time-based control of user access in a data processing system utilizing a Role-Based Access Control model. A computer implemented method for providing time-based control of user access in a data processing system utilizing a Role-Based Access Control model includes providing at least one timing attribute for a role, wherein each at least one timing attribute specifies a timing condition by which a user is enabled to use the role. The user is enabled to use the role pursuant to satisfying the at least one timing attribute.

### BACKGROUND OF THE INVENTION

1. Field of the Invention

The present invention relates generally to the data processing field and, more particularly, to a computer implemented method, system and computer usable program code for providing time-based control of user access in a data processing system utilizing a Role-Based Access Control model.

2. Description of the Related Art

Some operating systems, for example, UNIX® and Windows® operating systems, enable one or more users to be designated as having maximum privileges with respect to accessing and using resources in a data processing system. These users are referred to as a “super-users” or “roots”; and in traditional UNIX® operating systems, only a super-user has the ability to handle and manipulate all system resources. Only super-users are given the capability to run, kill or execute any program at any level of security.

In addition to root user programs, setuid programs have been historically used to change the identity of the operating process so that a privileged operation performed by a normal user can succeed. Basically, a setuid program is a program that executes with access rights of its owner. With this mechanism, however, there is a possibility of a security vulnerability loophole which could allow a hacker to take over the privileged operation to, for example, intentionally crash the data processing system.

In traditional UNIX® operating systems, only the super-user is enabled to perform administrative-type jobs with respect to a data processing system. With the advent of the Role-Based Access Control (RBAC) model, however, the traditional UNIX® model, with an all powerful super-user, has been changed. More particularly, RBAC is an enhancement that enables special privileges to be granted to normal users (non-super-users) on the basis of need. With the RBAC model, the functions and responsibilities of individual users are defined as roles, and each user is typically given only the minimum privileges that are actually necessary for the user to accomplish a particular task.

Many roles can be created within the RBAC model, with each role providing its own specific capabilities tailored to meet the needs of individual users and subject to satisfying security requirements. RBAC thus helps to provide a management policy for a data processing system based on organizational needs and without requiring the powerful root access to be granted outside the confines of a strictly limited group of super-users.

In the RBAC model, once a role has been defined for a particular user, that role will prevail until it is changed or revoked by the super-user. The RBAC model does not provide a capability of controlling access to resources granted to a normal user via a role on the basis of time. Inability of the RBAC model to provide such a capability can be a significant drawback in many situations.

There is, accordingly, a need for a mechanism for providing time-based control of user access in a data processing system utilizing a Role-Based Access Control model.

### SUMMARY OF THE INVENTION

Exemplary embodiments provide a computer implemented method, system and computer usable program code for providing time-based control of user access in a data processing system utilizing a Role-Based Access Control model. A computer implemented method for providing time-based control of user access in a data processing system utilizing a Role-Based Access Control model includes providing at least one timing attribute for a role, wherein each at least one timing attribute specifies a timing condition by which a user is enabled to use the role. The user is enabled to use the role pursuant to satisfying the at least one timing attribute.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an exemplary embodiment when read in conjunction with the accompanying drawings, wherein:

FIG. 1 depicts a pictorial representation of a network of data processing systems in which exemplary embodiments may be implemented;

FIG. 2 is a block diagram of a data processing system in which exemplary embodiments may be implemented;

FIG. 3 is a diagram that schematically illustrates a manner by which users are enabled to perform particular functions in a data processing system utilizing an RBAC model to assist in explaining exemplary embodiments;

FIG. 4 is a diagram that schematically depicts an example of granular breakup into smaller units or roles to be managed by normal users in an RBAC model to assist in explaining exemplary embodiments;

FIG. 5 is a diagram that schematically illustrates a current implementation of the RBAC model to assist in explaining exemplary embodiments;

FIG. 6 is a diagram that schematically illustrates an implementation of an RBAC model according to an exemplary embodiment; and

FIG. 7 is a flowchart that illustrates a method for providing time-based control of user access in a data processing system utilizing an RBAC model according to an exemplary embodiment.

### DETAILED DESCRIPTION OF THE PREFERRED EMBODIMENT

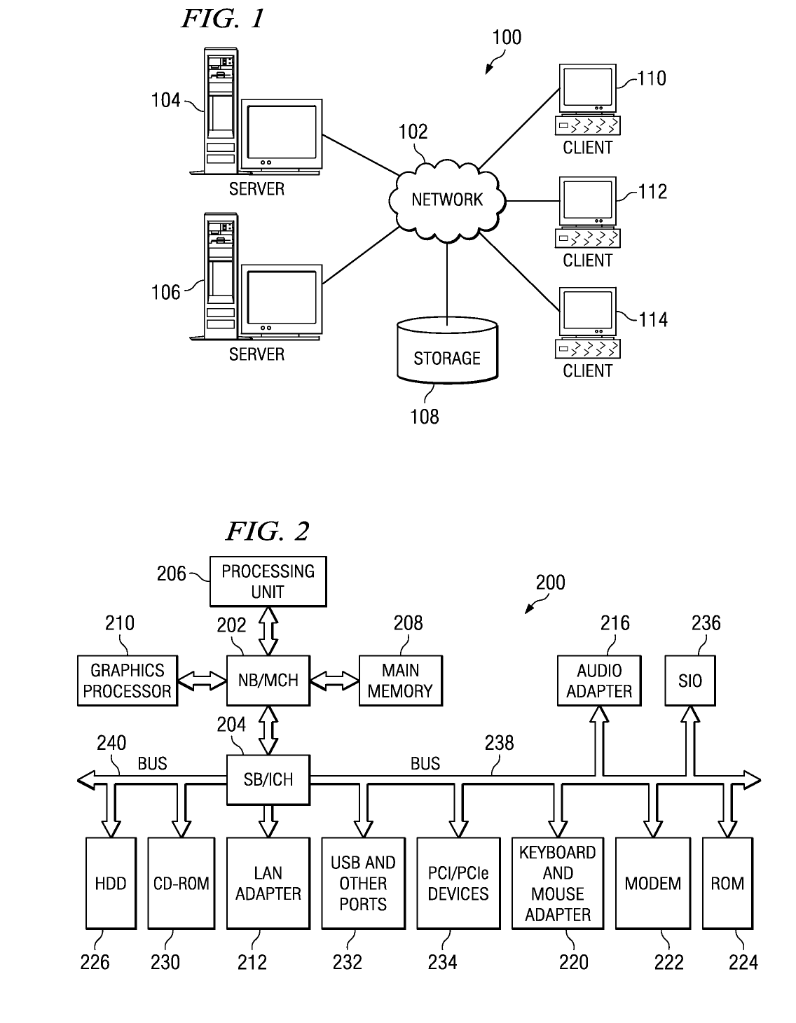

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which exemplary embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different exemplary embodiments.

With reference now to FIG. 2, a block diagram of a data processing system is shown in which exemplary embodiments may be implemented. Data processing system 200 is an example of a computer, such as server 104 or client 110 in FIG. 1, in which computer usable program code or instructions implementing the processes may be located for the exemplary embodiments.

In the depicted example, data processing system 200 employs a hub architecture including a north bridge and memory controller hub (NB/MCH) 202 and a south bridge and input/output (I/O) controller hub (SB/ICH) 204. Processing unit 206, main memory 208, and graphics processor 210 are coupled to north bridge and memory controller hub 202. Processing unit 206 may contain one or more processors and may even be implemented using one or more heterogeneous processor systems. Graphics processor 210 may be coupled to the NB/MCH through an accelerated graphics port (AGP), for example.

In the depicted example, local area network (LAN) adapter 212 is coupled to south bridge and I/O controller hub 204 and audio adapter 216, keyboard and mouse adapter 220, modem 222, read only memory (ROM) 224, universal serial bus (USB) and other ports 232, and PCI/PCIe devices 234 are coupled to south bridge and I/O controller hub 204 through bus 238, and hard disk drive (HDD) 226 and CD-ROM 230 are coupled to south bridge and I/O controller hub 204 through bus 240. PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206 and coordinates and provides control of various components within data processing system 200 in FIG. 2. The operating system may be a commercially available operating system such as a Windows® or UNIX® operating system although it should be understood that exemplary embodiments are not limited to being used with any particular operating system. An object oriented programming system, such as the Java™ programming system, may run in conjunction with the operating system and provides calls to the operating system from Java™ programs or applications executing on data processing system 200. Java™ and all Java™-based trademarks are trademarks of Sun Microsystems, Inc. in the United States, other countries, or both.

Instructions for the operating system, the object-oriented programming system, and applications or programs are located on storage devices, such as hard disk drive 226, and may be loaded into main memory 208 for execution by processing unit 206. The processes of the illustrative embodiments may be performed by processing unit 206 using computer implemented instructions, which may be located in a memory such as, for example, main memory 208, read only memory 224, or in one or more peripheral devices.

The hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the exemplary embodiments may be applied to a multiprocessor data processing system.

In some illustrative examples, data processing system 200 may be a personal digital assistant (PDA), which is generally configured with flash memory to provide non-volatile memory for storing operating system files and/or user-generated data. A bus system may be comprised of one or more buses, such as a system bus, an I/O bus and a PCI bus. Of course the bus system may be implemented using any type of communications fabric or architecture that provides for a transfer of data between different components or devices attached to the fabric or architecture. A communications unit may include one or more devices used to transmit and receive data, such as a modem or a network adapter. A memory may be, for example, main memory 208 or a cache such as found in north bridge and memory controller hub 202. A processing unit may include one or more processors or CPUs. The depicted examples in FIGS. 1-2 and above-described examples are not meant to imply architectural limitations. For example, data processing system 200 also may be a tablet computer, laptop computer, or telephone device in addition to taking the form of a PDA.

Exemplary embodiments provide a computer implemented method, system and computer usable program code for providing time-based control of user access in a data processing system utilizing a Role-Based Access Control (RBAC) model. Exemplary embodiments can be implemented in a processing unit in a data processing system such as processing unit 206 in data processing system 200 in FIG. 2.

As described previously, the RBAC model is an enhancement to operating systems, such as UNIX® operating systems, that enables special privileges to be granted to normal users, as distinguished from super-users or roots, on the basis of need. With the RBAC model, the unique functions and responsibilities of individual users are defined as “roles”, and each user is typically given only the minimum privileges that are actually needed to accomplish a particular task.

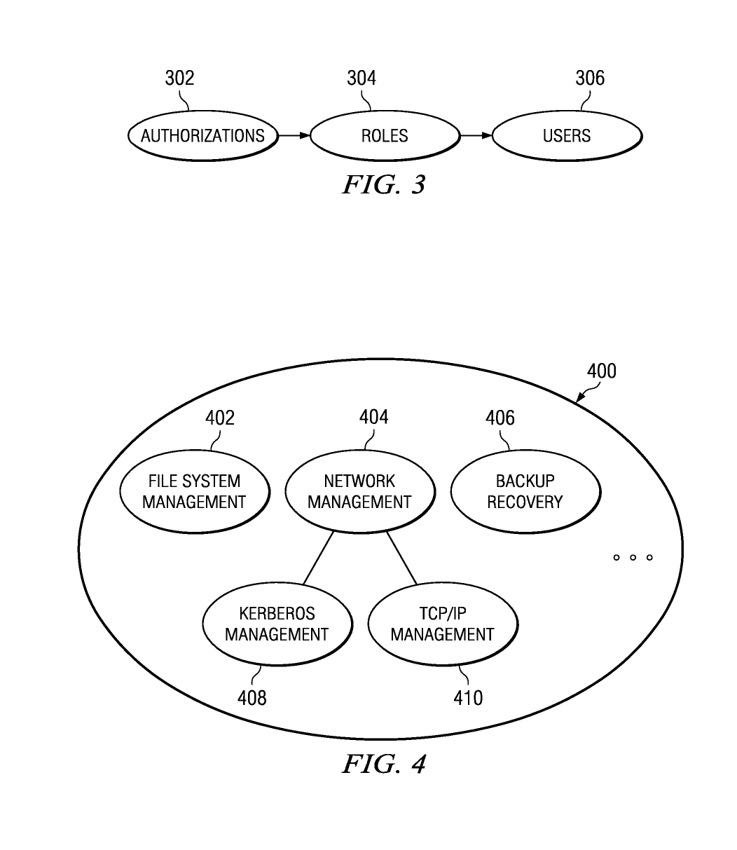

More specifically, in the RBAC model, a role is an authorization, or a combination of authorizations, that is assigned to particular users by a super-user. FIG. 3 is a diagram that schematically illustrates a manner by which users are enabled to perform particular functions in a data processing system utilizing an RBAC model to assist in explaining exemplary embodiments. As Shown in FIG. 3, one or more authorizations 302 are assigned to one or more roles 304 which, in turn, are assigned to one or more users 306. Each role has a specific identifier (Role ID) that is used to identify the role and to assign the role to particular users.

The RBAC model enables many roles to be created with each role providing its own specific capabilities that may be tailored to satisfy a security policy with respect to individual users. With the RBAC model, an overall system management policy can be provided that is based on organizational needs and does not require the powerful root access to be granted outside the confines of a strictly limited group of users.

FIG. 4 is a diagram that schematically illustrates an example of granular breakup into smaller units or roles to be managed by normal users in an RBAC model to assist in explaining exemplary embodiments. As shown in FIG. 4, management functions of a data processing system, generally designated by reference number 400, can be split up into smaller units that can be assigned to normal users via roles. FIG. 4 illustrates management functions 400 separated into file system management function 402, network management function 404 and backup recovery function 406. FIG. 4 also illustrates that a particular management function, e.g., network management function 404, can, in turn, be split into sub-units including Kerberos management function 408 and TCP/IP management function 410. By dividing the overall management function into functional units, such as functional units 402-406 or functional sub-units 408-410, any one or more management functions can be assigned to roles and the roles can be assigned to particular users by a super-user on an as needed basis. Of course, it should be understood that FIG. 4 is intended as an example only of a manner in which management functions can be split. Management and other functions can be split up in numerous ways and it is not intended to limit exemplary embodiments to any particular type of functions or to any particular manner of splitting a function. The management functions indicated here can be represented as authorizations as well, and authorizations are assigned to roles which in turn are assigned to users as schematically shown in FIG. 3.

In current implementations of the RBAC model, once a role is defined and assigned to a user, the role will prevail until changes are initiated by a super-user or until the role is revoked by the super-user. RBAC does not provide a capability of permitting time-based control of user access in a data processing system incorporating an RBAC model. This inability in current implementations of the RBAC model can be a significant drawback in situations where, for example, a super-user wishes to restrict the role of a user to perform a particular job to particular times or within a particular time period.

Exemplary embodiments provide a computer implemented method, system and computer usable program code for permitting a normal user to be granted super-user type privileges through roles via the RBAC model in a time-based manner with specific timing attributes. More particularly, according to exemplary embodiments, at least one timing attribute that specifies a timing condition by which a user is enabled to use a role is provided. The at least one timing attribute may be added to existing attributes which define a role, or the timing attributes can be a separate object having its own Role ID.

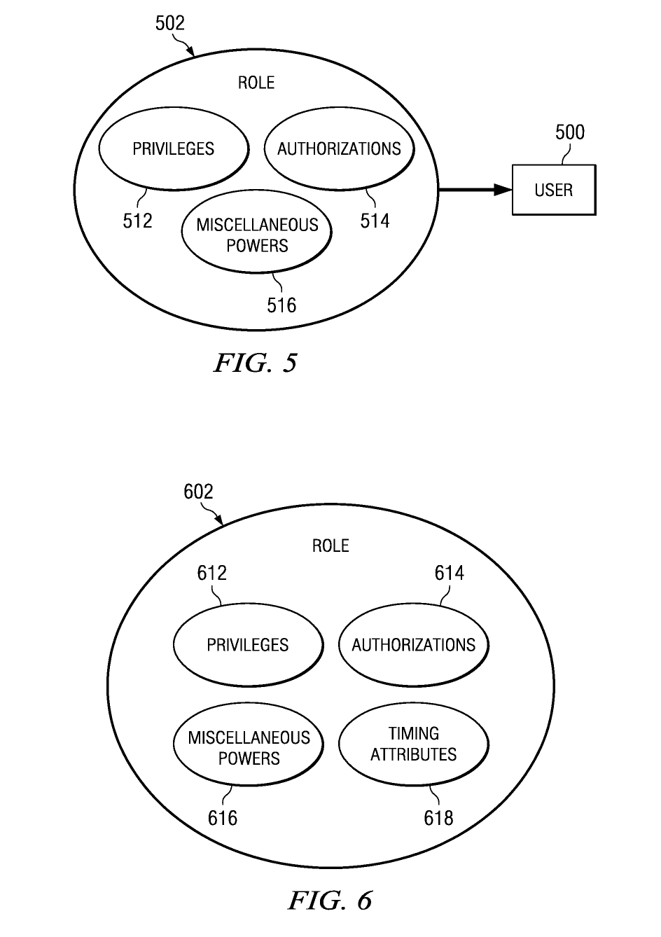

FIG. 5 is a diagram that schematically illustrates a current implementation of the Role Based Access Control model to assist in explaining exemplary embodiments. As shown in FIG. 5, in a current RBAC model implementation, a user 500 is assigned a role 502. Each role 502 has some secure attributes including privileges 512, authorizations 514 and miscellaneous powers 516. In an RBAC framework, users are granted membership into roles with the concept of least privilege, therefore restricting each user to a domain with those granted privileges and nothing more.

Elements of RBAC include authorizations, privileges and roles. Authorizations are an important entity. Various applications and operating systems will base their security decisions on the authorizations that are endowed on a particular role. Authorizations form a hierarchical chain which defines a role. For example, a system is in the highest order of hierarchy with its child network, with its grandchildren having great grand children as in system->network->manage->Kerberos representing network management for Kerberos on the system. On the other hand, privileges are a part of the RBAC infrastructure that provides fine granular level of system functions. A user normally acquires privileges based on the authorizations granted to their role. That is, various system functions typically executed by a super user could be allowed to be used by normal users when they have relevant privilege. Privileges are typically mapped to bit masks and are used in kernel space to achieve privileged function specific security controls with ease. Miscellaneous powers could themselves contain authorizations and privileges.

Role 502 can take a variety of forms with multiple authorizations assigned to them. For example a role can be assigned an authorization on backup management that shall enable the user to which the role is given execute archival operations. Also printing authorization can be assigned to the same role. Thus, a user can have one or more privileged functions assigned, although it should be understood that it is not intended to limit exemplary embodiments to any particular types or number of roles.

According to an exemplary embodiment, the current RBAC model illustrated in FIG. 5 is extended to provide configurable time-based attributes to a role in addition to the privileges, authorizations and miscellaneous power attributes provided in current implementations. FIG. 6 is a diagram that schematically illustrates an RBAC model according to an exemplary embodiment. As shown in FIG. 6, a role 602 has, in addition to privileges 612, authorizations 614 and miscellaneous powers 616, an entity, referred to as “timing attributes” 618. Timing attributes 618 comprises an object that can, for example, be a system defined file, database or memory role file that includes various time-based fields that are described in detail below and that enable a super-user to control timing conditions pursuant to which a user is enabled to use the role. This provides the super-user with a more granular level of security with respect to roles assigned to users.

Consider a set (s) of roles (r) for a user (u) who can perform a program or job (j) for (n) times in a time frame (T). This can be indicated, for example, in one of the following object formats:
/etc/security/roles
   or

/etc/attributes.role

The format of the time-based attributes that are indicated in the above objects is:

<role id>:<timeframe>:<timeout>:<times>:<day>

wherein:
“role id” represents an identifier for a role with authorizations assigned to it;
“timeframe” is in hh:mm:ss format, with the symbol “#” representing a default condition indicating no limit or anytime;
“timeout” is in hh:mm:ss format, with the symbol “#” representing a default condition indicating anytime;
“times” indicates a number of times a user can execute the identified function or authorization in the given role in words (such as Once, Twice, Thrice, Forever; or in numerical order 1 or 2 or 3. Symbol “#” represents that the role can be applicable any number of times for the user.
“day” can be numbers in a comma-separated format such as 1, 4, 5 indicating that the user may use the role on Sunday, Wednesday, Friday. Symbol “#” indicates usage of role is enabled for any day of the week.

The “timeframe” is an attribute that specifies the period of time during which a user is authorized for privilege on the role. The user is enabled to invoke the privilege (invoke an authorized function or job) at any time during the specified timeframe. For example, if the timeframe is 15:30:00-20:30:00, the user is privileged to use the role anytime during the period 3:30 PM to 8:30 PM.

The “timeout” is an attribute that specifies the maximum length of time that the user can use the role after which the role is stripped away. For example, if the timeout is 72:36:36, the user is allowed to use the role for a cumulative time of 72 hours, 36 minutes and 36 seconds.

“Times” indicates the number of times the user can use the role with given authorizations. For example, if twice, then user can run the role twice anytime within the authorized timeframe and subject to satisfying other timing attributes that are specified.

“Day” indicates the days of the week the role can be active. For example, 1, 3, 5 indicates the role is active on Sunday, Tuesday and Thursday and can be applied on those days so long as other specified timing attributes are also satisfied.

According to an exemplary embodiment, certain fields or attributes in the /etc/security/roles or /etc/attributes.role role file or similar object can be non-mandatory. The role is applied on the user and the user shall need to strictly follow the rules on timing attributes as applicable for execution of the authorized function.

In general, exemplary embodiments allow a normal user without super-user privileges to be enabled to execute a required task with super-user privileges subject to super-user specified time-based limitations.

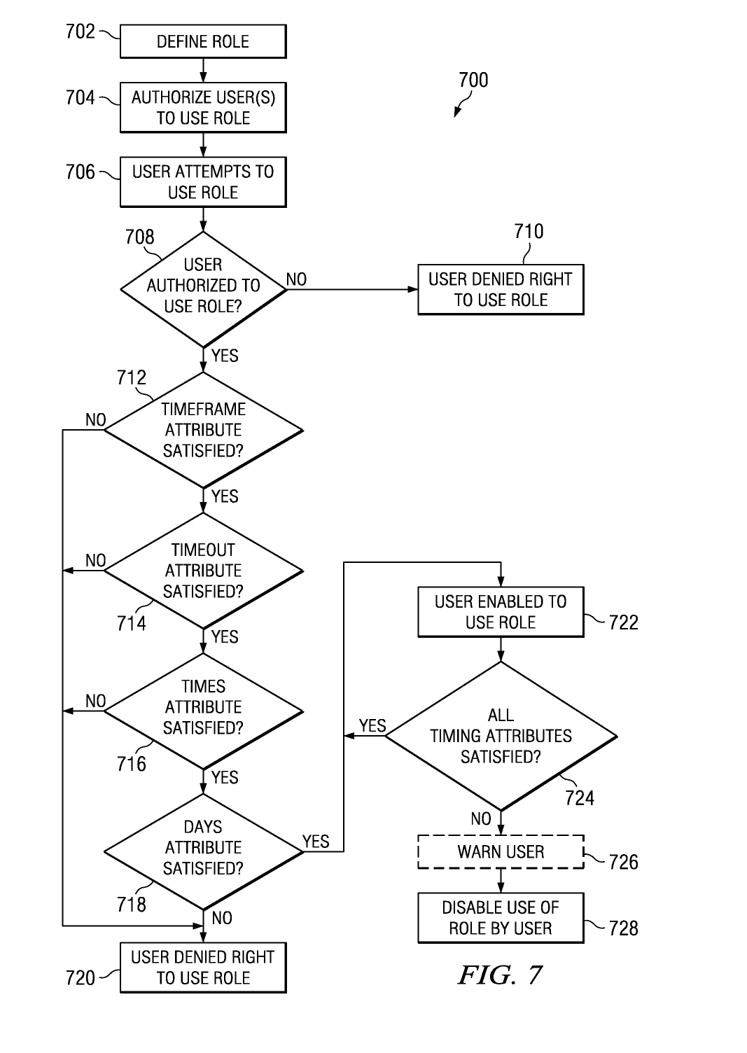

FIG. 7 is a flowchart that illustrates a computer implemented method for providing time-based control of user access in a data processing system utilizing a Role-Based Access Control model according to an exemplary embodiment. The method is generally designated by reference number 700, and begins by defining a role (Step 702). The role is defined by specifying attributes of the role including authorization attributes, privilege attributes and timing attributes. The timing attributes include one or more of a timeframe attribute, a timeout attribute, a times attribute and a day attribute. A particular user or users is then authorized to use the defined role subject to the attributes specified for the role (Step 704).

A user then attempts to use the role (Step 706). Responsive to a user attempt to use a role, a determination is made whether the user is authorized to use the role (Step 708). If the user is not an authorized user (No output of Step 708), the user is denied the right to use the role (Step 710). If the user is determined to be authorized to use the role (Yes output of Step 708), determinations are made whether the timing attributes specified for the role are satisfied. In the exemplary embodiment illustrated in FIG. 7, determinations are made with respect to a timeframe attribute (Step 712), a timeout attribute (Step 714), a times attribute (Step 716) and a days attribute (Step 718), although it should be understood that exemplary embodiments are not limited to roles having any particular timing attribute.

If any of the timing attributes specified in the role are not satisfied (No output of any one or more of Steps 712-718), the user is denied the right to use the role (Step 720). If all of the specified timing attributes are met (Yes output of each of Steps 712-718), the user is enabled to use the role (Step 722).

As the user is using the role, it is determined whether the specified timing attributes continue to be satisfied (Step 724). If all the timing attributes continue to be satisfied (Yes output of Step 724), the user is enabled to continue using the role. If, however, any one of the timing attributes is no longer met (No output of Step 724), the ability of the user to continue use of the role is disabled (Step 728). If the timing attributes are not satisfied by the user entitled to use a role, disabling may occur after a warning is presented to the user (Step 726) such as on a display screen of the user's computer.

Exemplary embodiments thus provide a computer implemented method, system and computer usable program code for providing time-based control of user access in a data processing system utilizing a Role-Based Access Control model. A computer implemented method for providing time-based control of user access in a data processing system utilizing a Role-Based Access Control model includes providing at least one timing attribute for a role, wherein each at least one timing attribute specifies a timing condition by which a user is enabled to use the role. The user is enabled to use the role pursuant to satisfying the at least one timing attribute.

The invention can take the form of an entirely hardware embodiment, an entirely software embodiment or an embodiment containing both hardware and software elements. In an exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

Further, a computer storage medium may contain or store a computer readable program code such that when the computer readable program code is executed on a computer, the execution of this computer readable program code causes the computer to transmit another computer readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for providing time-based control of user access in a data processing system utilizing a Role-Based Access Control model, the computer implemented method comprising:
providing at least one timing attribute for a role, wherein each at least one timing attribute specifies a timing condition by which a user is enabled to use the role; and
enabling the user to use the role pursuant to satisfying the at least one timing attribute.

2. The computer implemented method according to claim 1, wherein the at least one timing attribute comprises at least one of a timeframe attribute that specifies a period of time during which the user is enabled to use the role, a timeout attribute that specifies a maximum length of time that the user is enabled to use the role, a times attribute that specifies a number of times the user is enabled to use the role for a particular job, and a days attribute that specifies days of the week the user is enabled to use the role.

3. The computer implemented method according to claim 1, wherein the at least one timing attribute is included with other attributes defining the role.

4. The computer implemented method according to claim 1, wherein the at least one timing attribute is in an object separate from the role.

5. The computer implemented method according to claim 1, and further comprising:
disabling use of the role by the user if any one of the at least one timing attribute is not satisfied.

6. The computer implemented method according to claim 5, and further comprising:
warning the user prior to disabling use of the role.

7. The computer implemented method according to claim 1, wherein at least one of the at least one timing attribute comprises a default condition specifying a timing condition that includes no timing restriction with respect to the at least one of the at least one timing attribute.

8. The computer implemented method according to claim 1, wherein the data processing system comprises one of a UNIX® and a Windows® operating system.

9. A computer program product, comprising:
a computer usable medium having computer usable program code configured for providing time-based control of user access in a data processing system utilizing a Role-Based Access Control model, the computer program product comprising:
computer usable program code configured for providing at least one timing attribute for a role, wherein each at least one timing attribute specifies a timing condition by which a user is enabled to use the role; and
computer usable program code configured for enabling the user to use the role pursuant to satisfying the at least one timing attribute.

10. The computer program product according to claim 9, wherein the at least one timing attribute comprises at least one of a timeframe attribute that specifies a period of time during which the user is enabled to use the role, a timeout attribute that specifies a maximum length of time that the user is enabled to use the role, a times attribute that specifies a number of times the user is enabled to use the role for a particular job, and a days attribute that specifies days of the week the user is enabled to use the role.

11. The computer program product according to claim 9, and further comprising:
computer usable program code configured for disabling use of the role by the user if any one of the at least one timing attribute is not satisfied.

12. The computer program product according to claim 11, and further comprising:
computer usable program code configured for warning the user prior to disabling use of the role.

13. The computer program product according to claim 9, wherein at least one of the at least one timing attribute comprises a default condition specifying a timing condition that includes no timing restriction with respect to the at least one of the at least one timing attribute.

14. A system for providing time-based control of user access in a data processing system utilizing a Role-Based Access Control model, comprising:
a role having role attributes specifying privileges granted to a user;
means for providing at least one timing attribute for the role, wherein each at least one timing attribute specifies a timing condition by which a user is enabled to use the role; and
means for enabling the user to use the role pursuant to satisfying the at least one timing attribute.

15. The system according to claim 14, wherein the at least one timing attribute comprises at least one of a timeframe attribute that specifies a period of time during which the user is enabled to use the role, a timeout attribute that specifies a maximum length of time that the user is enabled to use the role, a times attribute that specifies a number of times the user is enabled to use the role for a particular job, and a days attribute that specifies days of the week the user is enabled to use the role.

16. The system according to claim 14, wherein the at least one timing attribute is included with role attributes defining the role.

17. The system according to claim 14, wherein the at least one timing attribute is in an object separate from the role.

18. The system according to claim 14, and further comprising:
means for disabling use of the role by the user if any one of the at least one timing attribute is not satisfied.

19. The system according to claim 14, wherein at least one of the at least one timing attribute comprises a default condition specifying a timing condition that includes no timing restriction with respect to the at least one of the at least one timing attribute.

20. The system according to claim 14, wherein the data processing system comprises one of a UNIX® or a Windows® operating system.
